(19) United States
(12) Patent Application Publication
(10) Pub. No.: US 2021/0048503 A1
(43) Pub. Date: Feb. 18, 2021

(54) MOTION DATA BASED PROCESSING TIME WINDOW FOR POSITIONING SIGNALS

(71) Applicant: Sony Corporation, Tokyo (JP)

(72) Inventors: Peter LJUNG, Lund (SE); Johan WADMAN, Lund (SE)

(21) Appl. No.: 16/966,896

(22) PCT Filed: Jan. 30, 2019
(86) PCT No.: PCT/EP2019/052240

§ 371 Date: Aug. 2, 2020

(30) Foreign Application Priority Data
Feb. 2, 2018 (SE) 1830034-3

(51) Int. Cl. G01S 5/00; G01S 5/02

(52) U.S. Cl. CPC G01S 5/0036; G01S 5/0236

(57) ABSTRACT

An object position is estimated on the basis of at least one positioning signal (PBS) from a transmitter on an object (30). Motion data from a sensor on the object (30) are used as a basis for determining a processing time window. Processing of the at least one positioning signal (PBS) and/or positioning data (PD) derived from the at least one positioning signal is accomplished based on the determined processing time window. The transmitter and the sensor may be integrated in a tag device (10) attached to the object (30).

### FIELD OF THE INVENTION

The present invention relates to methods for estimating an object position and to corresponding devices and systems.

### BACKGROUND OF THE INVENTION

For tracking an object, it is known to place a tag device on the object and use positioning signals transmitted by the tag device for estimating the position of the object. The positioning signals may for example be broadcast signals based on the Bluetooth Low Energy (BLE) technology or Ultrawide-band (UWB) technology. Repeated transmission and measurement of the positioning signals may allow for estimating the position of the object in a time-resolved manner.

However, accuracy of positioning data obtained on the basis of the broadcast positioning signals may in some cases be unsatisfactory. For example, the object may move at a time when no positioning signal is being transmitted, resulting in delayed or otherwise inaccurate detection of changes in of the position of the object. On the other hand, increasing a rate of transmitting the positioning signals may result in excessive battery drain of the tag device.

It is also known to add a motion sensor to the tag device and to control the transmission of positioning signals by a tag device based on motion data provided by the motion sensor. By way of example, U.S. Pat. No. 9,489,655 B1 describes providing a tag device with a motion sensor, such as an accelerometer or gyroscope, and using output of the motion sensor to broadcast positioning signals only when the output of the sensor indicates that the tag device is moving. In this case, the motion data are used for distinguishing different tag devices from each other.

In view of the above, there is a need for technologies allow for more efficiently and accurately estimating an object position based on positioning signals transmitted by a tag device or similar transmitter placed on an object.

### SUMMARY OF THE INVENTION

According to an embodiment, a method of estimating an object position is provided. According to the method, at least one positioning signal is received from a transmitter on an object. Further, motion data are received from a sensor on the object. The sensor may for example, comprise an accelerometer and/or a gyroscope. A processing time window is determined based on the motion data. The at least one positioning signal and/or positioning data derived from the at least one positioning signal are processed based on the determined processing time window. The processing may comprise averaging and/or filtering of the at least one positioning signal or of the positioning data, and the processing time window may be a time window applied for this averaging and/or filtering. The processing may also comprise sampling of the at least one positioning signal, and the processing time window may be a time window applied for sampling of the at least one positioning signal.

By using the motion data as a basis for determining the processing time window, processing of the positioning signal or of the positioning data can be adapted in a highly efficient manner. For example, the position of the object can be estimated with high accuracy and low noise while the object is not moving or moving slowly, by selecting a longer processing time window. On the other hand, a low latency of processing the at least one positioning signal or the positioning data can be achieved by selecting a shorter processing time window when the object is moving.

According to an embodiment, the positioning data are calculated based on the processed at least one positioning signal. The positioning data may for example comprise intermediate data to be used for calculating the position of the object, e.g., a signal strength of the at least one positioning signal, a signal travel time of the at least one positioning signal, a distance to the object, a reception angle of the at least one positioning signal, or the like. The positioning data may then be provided to a device which is responsible for calculating the position of the object from the positioning data. Accordingly, a distributed architecture may be utilized where multiple devices receive the at least one positioning signal and calculate the positioning data, which are then collected and further evaluated by the device responsible for calculating the position of the object. However, it is also possible that the processing of the received at least one positioning signal and the calculation of the position of the object is accomplished by the same device.

According to an embodiment, a first length of the processing time window is selected in response to the motion data indicating a first motion status, and in response to the motion data indication a second motion status with a lower mobility than the first motion status, a second length of the processing time window is selected, which is longer than the first length. For example, the first motion status could correspond to movement of the object with an acceleration or velocity above a threshold, whereas the second motion status could correspond to movement of the object with an acceleration or velocity below the threshold, or to the object being stationary. Accordingly, the processing time window may be shortened in response to the object being accelerated or moving faster than a certain minimum velocity, thereby reducing latency of the processing of the at least one positioning signal so that changes of the position of the object can be accurately tracked.

According to an embodiment, also a sampling rate applied for sampling of the at least one positioning signal may be selected based on the received motion data. For example, a higher sampling rate may be selected in response to the motion data indicating movement of the object with an acceleration or velocity above a threshold. In this way, accuracy of the estimated object position may be further improved in situations when the object is moving.

According to an embodiment, also an algorithm applied for the processing of the at least one positioning signal or of the positioning data may be selected based on the received motion data. For example, selection of the algorithm may involve selecting a filter applied for the processing. For example, a filter which puts increased weight on new input values may be selected in response to the motion data indicating movement of the object with an acceleration or velocity above a threshold. In this way, latency associated with said processing of the at least one positioning signal may be further reduced.

According to an embodiment, the transmitter and the sensor are comprised in a tag device attached to the object. In this way, various types of objects can be tracked by simply attaching the tag device to the object. However, it is noted that in some scenarios the transmitter and the sensor could also be part of the object itself. For example, the object could be an electronic device equipped with the transmitter and the sensor, such as a mobile phone of similar communication device. In still further application scenarios, the object could be a vehicle, and the transmitter and the sensor could be part of an on-board electronic system of the vehicle.

According to a further embodiment, a device for estimating an object position is provided. The device comprises an interface for receiving at least one positioning signal from a transmitter on an object or for receiving positioning data derived from at least one positioning signal from a transmitter on an object, and for receiving motion data from a sensor on the object. Further, the device comprises at least one processor. The at least one processor is configured to determine a processing time window based on the received motion data. Further, the at least one processor is configured to process the at least one positioning signal or the positioning data based on the determined processing time window.

According to an embodiment, the device comprises a further interface configured for sending positioning data calculated based on the processed at least one positioning signal to a further device which is responsible for calculating a position of the object from the positioning data.

The device may be configured to operate according to the above method. Accordingly, the at least one processor of the device may be configured to calculate positioning data based on the processed at least one positioning signal. In this case, the at least one processor may be configured to send the positioning data to a device which is responsible for calculating a position of the object from the positioning data, using the above-mentioned further interface.

Further, the at least one processor may be configured to select a first length of the processing time window in response to the motion data indicating a first motion status, and select a second length of the processing time window, which is longer than the first length, in response to the motion data indication a second motion status with a lower mobility than the first motion status.

If the processing of the at least one positioning signal or of the positioning data derived from the at least one positioning signal comprises averaging, the processing time window may comprise a time window applied for averaging of the at least one positioning signal or of the positioning data derived from the at least one positioning signal. If the processing comprises sampling of the at least one positioning signal, the processing time window may comprise a time window applied for sampling of the at least one positioning signal.

Further, the at least one processor may be configured to select, based on the received motion data, a sampling rate applied for sampling of the at least one positioning signal.

Further, the at least one processor may be configured to select, based on the received motion data, an algorithm applied for the processing of the at least one positioning signal or for the processing of the positioning data derived from the at least one positioning signal.

Further, the at least one processor may be configured to select, based on the received motion data, a filter applied for the processing of the at least one positioning signal or for the processing of the positioning data derived from the at least one positioning signal.

Like in the above-mentioned method, the sensor may comprise an accelerometer and/or a gyroscope. The transmitter and the sensor may be comprised in a tag device attached to the object.

According to a further embodiment, a system is provided. The system comprises the above-mentioned device for estimating an object position and a tag device attached to the object. The tag device comprises the transmitter and the sensor.

The above and further embodiments of the invention will now be described in more detail with reference to the accompanying drawings.

### BRIEF DESCRIPTION OF THE DRAWINGS

FIG. 1 schematically illustrates an exemplary scenario in which an object position is estimated according to an embodiment of the invention.

FIG. 2 schematically illustrates a further exemplary scenario in which an object position is estimated according to an embodiment of the invention.

FIGS. 3A and 3B illustrate examples of adjusting a processing time window according to an embodiment of the invention.

FIG. 4 schematically illustrates a tag device as used according to an embodiment of the invention.

FIG. 5 shows a flowchart for illustrating a method according to an embodiment of the invention.

FIG. 6 schematically illustrates a processor-based implementation of an observer device according to an embodiment of the invention.

FIG. 7 schematically illustrates a processor-based implementation of a locator device according to an embodiment of the invention.

### DETAILED DESCRIPTION OF EMBODIMENTS

In the following, exemplary embodiments of the invention will be described in more detail. It has to be understood that the following description is given only for the purpose of illustrating the principles of the invention and is not to be taken in a limiting sense. Rather, the scope of the invention is defined only by the appended claims and is not intended to be limited by the exemplary embodiments described hereinafter.

The illustrated embodiments relate to estimation of an object position, e.g., with the aim of tracking the object in an indoor or outdoor environment. For this purpose, a tag device is placed on the object. The tag device is equipped with a transmitter for sending positioning signals. Further, the tag device is equipped with a motion sensor, e.g., an accelerometer and/or a gyroscope. The tag device is configured to report motion data obtained from the motion sensor so as to allow utilization of the motion data for optimizing processing of the positioning signals at a receiver. As further detailed below, the motion data may be used for determining and adjusting a processing time window applied for processing of the positioning signals.

By utilization of the motion sensor in the tag device and by reporting the motion data provided by the sensor, the object position can be estimated with enhanced performance. In particular, in situations where the object is moving fast, estimates of the object position can be provided with reduced latency. On the other hand, low noise estimates of the object position can be provided in scenarios where the object is stationary or moving only slowly.

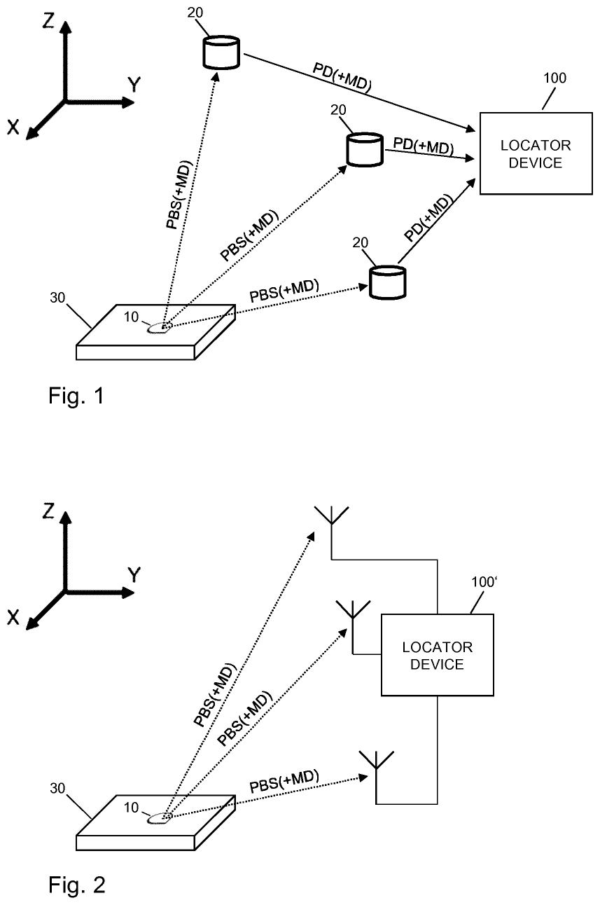

FIG. 1 shows an example of a scenario in which a tag device 10 and multiple observer devices 20 are used for tracking an object 30. As shown in FIG. 1, the tag device 10 is attached to the object 10, e.g., by permanent or nonpermanent gluing, by magnetic force, by suction effect, by screw fixation, or the like. The tag device 10 broadcasts positioning signals, in the following referred to as positioning broadcast signal (PBS). The positioning broadcast signals may for example be based on a BLE technology, a UWB technology, or a WiFi technology. As indicated above, the tag device 10 is equipped with a motion sensor, e.g., in the form of an accelerometer and/or a gyroscope. The motion sensor may for example be implemented on the basis of a MEMS (micro-electromechanical system) technology. In the illustrated example, it is assumed that measurement data (MD) provided by the motion sensor are broadcasted with the PBS, e.g., by encoding the measurement data in the PBS. Further, an identifier of the tag device 10 may be encoded in the PBS. For example, the PBS may be encoded as part of the identifier. In this way, the PBS may be enhanced to also convey the motion data, while at the same time maintaining compatibility with existing positioning signal formats, such as the iBeacon format or the Eddystone format.

The PBS are received by the observer devices 20. The observer devices 20 process the received PBS to evaluate positioning data (PD). The positioning data may for example include an estimate of a distance between the observer device 20 and the tag device 10 and/or and reception angle of the PBS at the observer device 20. The evaluation of the positioning data may for example be based on measurement of a signal strength of the PBS as received by the observer device 20, e.g., in terms of an RSSI (Received Signal Strength Indicator). In some scenario, the evaluated positioning data may also include an indication of the measured signal strength or the measured reception angle. The positioning data may be evaluated in a time-resolved manner, by considering the times when the PBS were received by the respective observer device. Corresponding time indications may also be included in the positioning data evaluated by the observer devices 20.

In the scenario of FIG. 1 the evaluated positioning data assumed to be intermediate data, to be further evaluated so as to calculate a position of the object 30. Specifically, in the scenario of FIG. 1 the PBS are received by multiple observer devices, which each evaluate the positioning data and indicate their respectively evaluated positioning data to a locator device 100. The locator device 100 is responsible for combining the positioning data provided by the different observer devices 20 so as to calculate the position of the object 30. For example, the locator device 100 may calculate the position of the object 30 in terms of three-dimensional coordinates, such as x, y, and z coordinates as illustrated in FIG. 1. These calculations may for example involve trilateration calculations and/or triangulation calculations based on the positioning data provided by the different observer devices 20. The position of the object 30 may be calculated in a time-resolved manner, using the above-mentioned time indications included in the positioning data.

As mentioned above, processing of the received PBS is based on a processing time window which is determined depending on the motion data provided by the motion sensor of the tag device 10. This processing may for example involve averaging of the received PBS or averaging of positioning data derived from the received PBS. Further, this processing may involve sampling of the received PBS. In the example of FIG. 1, it is assumed that this processing is accomplished by each of the observer devices 20. Accordingly, each of the observer devices 20 may use the motion data provided together with the PBS to select an appropriate processing time window.

In the scenario of FIG. 1, the motion data may also be conveyed together with the positioning data to the locator device 100, which may then use the motion data provided together with the positioning data to select an appropriate processing time window for further processing the received positioning data. The processing of the received positioning data by the locator device 100 may for example involve averaging and/or filtering of the received positioning data, using the determined processing time window. The locator device 100 may then use the processed positioning data to calculate the position of the object 30.

FIG. 2 shows a further example of a scenario in which a tag device 10 and a locator device 100′ with multiple reception antennas are used for tracking an object 30. Like in the scenario of FIG. 1, the tag device 10 is attached to the object 10 and broadcasts PBS. As compared to the scenario of FIG. 1, in the scenario of FIG. 2 uses no separate observer devices, but the PBS are received and further processed by the locator device 100′. In order to improve spatial resolution, the multiple antennas locator device 100′ may be distributed in at different positions. Further, also in the scenario of FIG. 2 the tag device 10 is equipped with a motion sensor, and measurement data (MD) provided by the motion sensor are broadcasted with the PBS, e.g., by encoding the measurement data in the PBS. Further, an identifier of the tag device 10 may be encoded in the PBS.

In the example of FIG. 2, processing of the PBS is accomplished by the locator device 100′. Accordingly, the locator device 100′ may use the motion data provided together with the PBS to select an appropriate processing time window. This processing may for example involve averaging of the received PBS or averaging of intermediate positioning data derived from the received PBS. The locator device 100′ then uses the processed PBS or intermediate positioning data to calculate the position of the object 30. For example, the locator device 100′ may calculate the position of the object 30 in terms of three-dimensional coordinates, such as x, y, and z coordinates as illustrated in FIG. 2. These calculations may for example involve trilateration calculations and/or triangulation calculations using PBS received by different antennas. The position of the object 30 may be calculated in a time-resolved manner, depending on the time when the PBS were received by the locator device 100′.

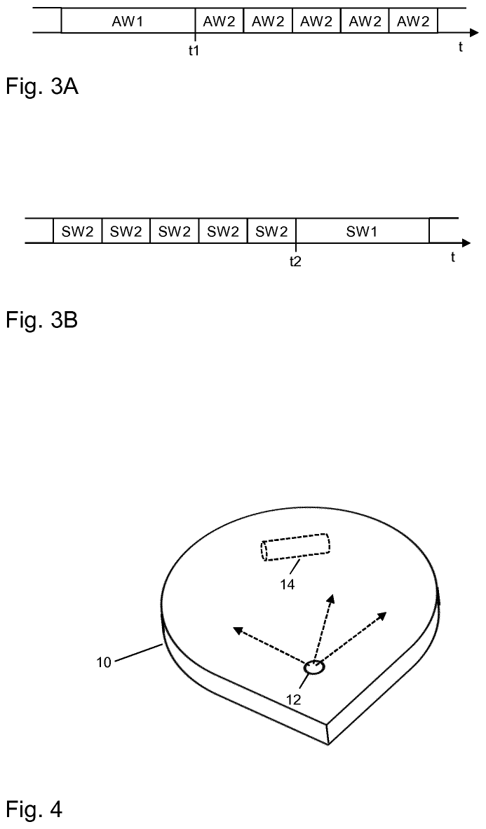

The determination and adjustment of the processing time window may in particular involve using a shorter processing time window if the motion data indicate a high mobility of the object 30, e.g., if the motion data indicate an acceleration above a threshold and/or a velocity above a threshold. Further, this may involve using a longer processing time window if the motion data indicate a low mobility of the object 30, e.g., if the motion data indicate an acceleration below a threshold and/or a velocity below a threshold or if the motion data indicate that the object is stationary. FIGS. 3A and 3B illustrate corresponding examples of dynamically adjusting the length of the processing time window.

In the example of FIG. 3A, the length of an averaging time window is adjusted based on the motion data provided by the motion sensor. In particular, FIG. 3A show a sequence of averaging time windows AW1, AW2 as a function of time t. Initially, a long averaging time window AW1 is applied, e.g., in response to the motion data indicating that the object 30 is stationary or moving with acceleration and/or velocity below a threshold. From time t1, a shorter averaging time window AW2 is applied, e.g., in response to the motion data indicating that the object 30 is no longer stationary or moving with acceleration and/or velocity above a threshold.

In the example of FIG. 3B, the length of a sampling time window is adjusted based on the motion data provided by the motion sensor. In particular, FIG. 3B show a sequence of sampling time windows SW1, SW2 as a function of time t. Initially, a short sampling time window SW1 is applied, e.g., in response to the motion data indicating that the object 30 is non-stationary or moving with acceleration and/or velocity above a threshold. From time t2, a longer sampling time window SW2 is applied, e.g., in response to the motion data indicating that the object 30 is now stationary or moving with acceleration and/or velocity below a threshold.

Further, also algorithms applied for processing and/or further evaluating the PBS may be selected depending on the motion data provided by the motion sensor. For example, such algorithms could involve utilization of different filter functions for the processing of the PBS or for processing of positioning data derived by evaluation of the PBS. For example, when the motion data provided by the motion sensor indicate that the object 30 is stationary or moving with acceleration and/or velocity below a threshold, a filter function could be applied which puts substantially equal weight on past input data and newly received input data, such as a square filter function. When the motion data provided by the motion sensor indicate that the object 30 is non-stationary or moving with acceleration and/or velocity above a threshold, a filter function applied which puts more weight on newly received input data. In some cases, also a filter function may be applied which considers the motion indicated by the motion data, such as a particle filter function.

FIG. 4 further illustrates an implementation of the tag device 10. As illustrated in FIG. 4, the tag device 10 includes the transmitter 12 and the motion sensor 14. The motion sensor 14 may for example include an accelerometer configured for measurement of linear acceleration along three orthogonal axes and a gyroscope configured for measurement of angular acceleration about these three orthogonal axes. The accelerometer and gyroscope may for example be implemented using MEMS technology. However, it is noted that this implementation of the motion sensor 14 is merely exemplary and that in alternative implementations, the sensor system 14 could include only an accelerometer or only a gyroscope, or that the accelerometer and/or the gyroscope could support less measurement axes, e.g., only two orthogonal axes. The transmitter 12 may be based on various technologies. For example, the transmitter 12 may use a BLE technology or an UWB technology for transmitting the PBS and the motion data. However, other technologies are possible as well. For example, the positioning signals could also correspond to ultrasound signals, while the motion data are transmitted using a BLE technology. Still further, it is noted that the tag device 10 may of course also include other components, such as a controller or processor configured to control operation of the transmitter 12 and the motion sensor 14. Such controller or processor may also be responsible for generation of the PBS and encoding of the motion data.

As can be seen, the consideration of the motion data provided by the motion sensor 14 may allow for achieving a dynamically controlled trade-off of precision and latency in the processing and further evaluation of the PBS. When the tag device 10 is moving the observer devices 20 and/or the locator devices 100, 100′ may apply low-latency processing, e.g., using a short processing time window, low-complexity filtering or no filtering, and/or high update frequency. When the tag device 10 becomes stationary, transmission of the PBS and motion data by the tag device 10 may continue for a while, and the motion data may be used by the observer devices 20 and/or the locator device 100, 100′ to detect that the movement stopped and then accumulate data to have a larger data basis for averaging, filtering, or similar processing to reduce noise or fluctuations of the estimated object position. At some point, the tag device 10 may stop transmitting the PBS and motion data. The locator device 100, 100′ may then lock the present estimate of the object position new movement is detected by the tag device 10.

Further, it is noted that the motion data provided by the motion sensor 14 May also be used for other purposes, e.g., for control processes within the tag device 10. For example, the motion data could be used for controlling the transmission of the PBS by the tag device 10. In this way, the transmission of the PBS could be controlled in such a way that the PBS are transmitted only when the motion data indicate that the tag device 10 or object 30 is moving, and optionally also for a short time period after the movement stopped. Accordingly, the motion data can be used as a basis for controlling when or how often the tag device 10 transmits the PBS, i.e., a rate or timing of transmitting the PBS. By transmitting the PBS more often when the tag device 10 moves or moves with acceleration and/or velocity above a threshold, it also becomes possible to obtain more samples of the PBS at the receiver side, i.e., at the observer devices 20 or at the locator device 100′. Further, the motion data could also be used for controlling a transmit power of the PBS, i.e., by using a higher transmit power when the tag device 10 moves or moves with acceleration and/or velocity above a threshold.

By controlling the transmission timing or power based on the motion data, power consumption of the tag device 10 can be reduced. Further, also potential interference or disturbances caused by the PBS can be reduced, which in turn may allow for coexistence of more tag devices in a limited area, i.e., enable a higher spatial density of tag devices 10 without excessive risk of colliding or otherwise interfering transmissions of different tag devices.

Further, the motion data may also be used for providing improved accuracy for tracking movements of the object. For example, if the estimates of the object position are used as a basis for calculating a moved distance, noise or fluctuations of the estimated object position may produce an error in the calculated moved distance. Based on the motion data, the noise or fluctuations of the estimated object position can be reduced and thereby the accuracy of the calculated moved distance be enhanced. For example, by locking the estimate of the object position if the motion data indicate that the object 30 and the tag device 10 are stationary, it can be avoided that there is false detection of movement due to noise or fluctuations of the estimated object position, thereby avoiding that the noise or fluctuations cause an error in the calculated moved distance.

Further, if the object 30 corresponds to certain kinds of equipment, the motion data may be used as a basis for detecting usage time of the equipment. For example, small amounts of motion, which are typically not detectable on the basis of the PBS alone, could be used for deciding whether the equipment is being held or otherwise handled by a user or not. Still further, the motion data could also be used for detecting events like falls, bums, or hits on the object 30. Such events could be documented. Further, if the object 30 corresponds to certain kinds of equipment, such events may be used for detecting a need for a recalibration of the equipment or other maintenance procedures.

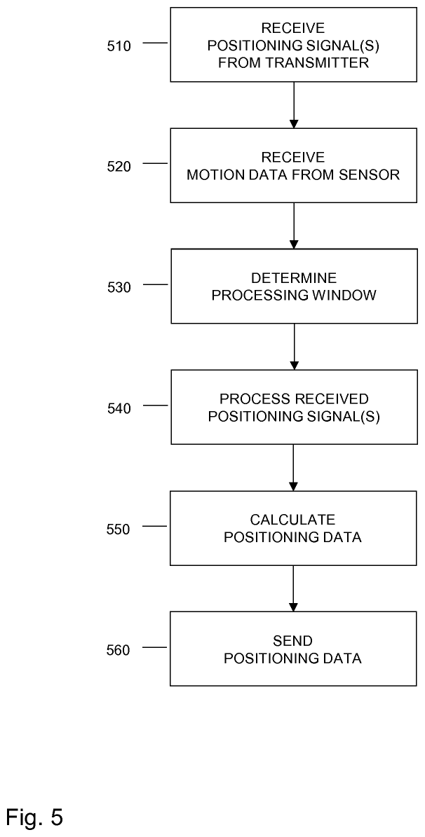

FIG. 5 shows a flowchart illustrating a method of estimating an object position using concepts as described above. At least a part of the method may for example be implemented by an observer device which receives positioning signals, such as one of the above-mentioned observer devices 20. Further, at least a part of the method may for example be implemented by a locator device which calculates an object position on the basis of positioning signals, such as the above-mentioned locator device 100, 100′. If a processor based implementation of the observer device or locator device is utilized, at least a part of the steps of the method may be performed, controlled, and/or guided by one or more processors of the respective device. Further, the method could also be implemented by a system including the observer device or locator device and a tag device placed on the object, e.g., by the a system including the above-mentioned robot tag device 10, as well as the observer device 20 and/or the locator device 100, 100′.

At step 510, at least one positioning signal is received from a transmitter on an object. The transmitter may be comprised in a tag device attached to the object. However, in some scenarios the transmitter could also be part of the object itself.

At step 520, motion data are received from a sensor on the object. The sensor may for example comprise an accelerometer and/or a gyroscope. Accordingly, the motion data may include a linear or angular acceleration. The motion data may also include a velocity, e.g., obtained by integrating measured accelerations.

Similar to the transmitter of step 510, the sensor may be comprised in a tag device attached to the object. As explained for the above-mentioned tag device 10, the transmitter and the sensor may be integrated within the same tag device. However, the sensor could also be part of the object itself. Further, the transmitter of step 510 and the sensor could be provided in different tag devices which are each attached to the object.

At step 530, a processing time window is determined based on the motion data. For example, a first length of the processing time window may be selected in response to the motion data indicating a first motion status, and in response to the motion data indication a second motion status with a lower mobility than the first motion status, a second length of the processing time window may be selected, which is longer than the first length. The first motion status could correspond to movement of the object with an acceleration or velocity above a threshold, whereas the second motion status could correspond to movement of the object with an acceleration or velocity below the threshold, or to the object being stationary. Accordingly, the processing time window may be shortened in response to the object being accelerated or moving faster than a certain minimum velocity, and the processing time window may be shortened in response to the object being substantially stationary or moving slowly.

In some scenarios, step 530 may also involve selecting a sampling rate applied for sampling of the at least one positioning signal based on the received motion data. For example, a higher sampling rate may be selected in response to the motion data indicating movement of the object with an acceleration or velocity above a threshold.

In some scenarios, step 530 may also involve selecting an algorithm applied for processing of the at least one positioning signal based on the received motion data. For example, selection of the algorithm may involve selecting a filter applied for processing of the at least one positioning signal. For example, a filter which puts increased weight on new input values may be selected in response to the motion data indicating movement of the object with an acceleration or velocity above a threshold.

At step 540, the at least one positioning signal is processed based on the determined processing time window. The processing of the at least one positioning signal may comprise averaging of the at least one positioning signal, and the processing time window may be a time window applied for averaging of the at least one positioning signal. The processing of the at least one positioning signal may also comprise sampling of the at least one positioning signal, and the processing time window may be a time window applied for sampling of the at least one positioning signal.

In some scenarios, the processing time window determined at step 530 may also be used for processing positioning data derived from at least one positioning signals. In this case, step 540 may be used to process the positioning data based on the determined processing time window, e.g., by averaging and/or filtering. For example, in the scenario explained in connection with FIG. 1, the locator device 100 could determine a processing time window based on the motion data from the sounds in the tag device 10 and then apply this processing time window for processing the positioning data received from the observer devices 20, e.g., by averaging or filtering.

At step 550, positioning data of the object may be calculated based on the processed at least one positioning signal. The positioning data may for example comprise intermediate data to be used for calculating the position of the object, e.g., a signal strength of the at least one positioning signal, a signal travel time of the at least one positioning signal, a distance to the object, a reception angle of the at least one positioning signal, or the like. Further, also the position of the object may be calculated, e.g., by using the above-mentioned positioning data as intermediate data.

At step 560, the positioning data calculated step 550 may be provided to a device which is responsible for calculating the position of the object from the positioning data, such as the locator device 100 in the scenario explained in connection with FIG. 100.

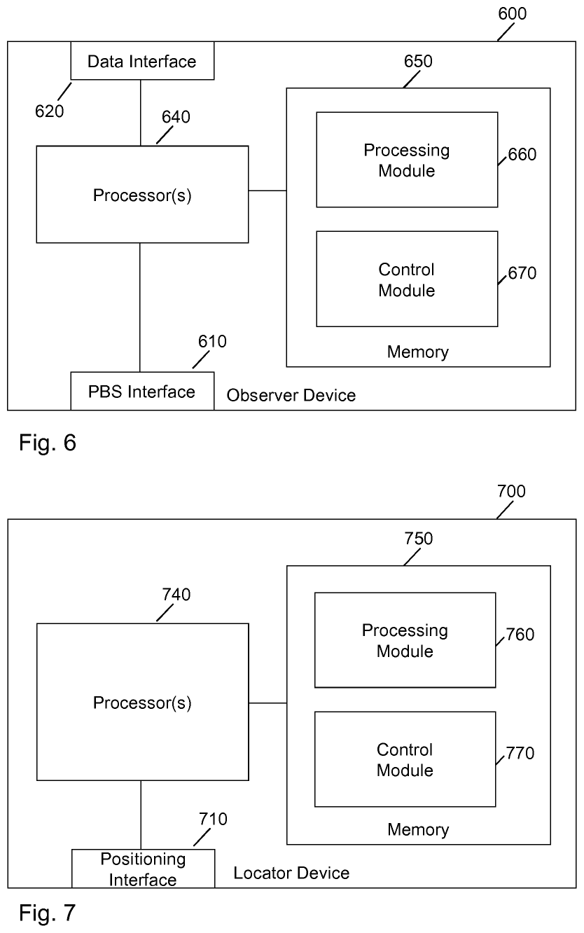

FIG. 6 shows a block diagram for schematically illustrating a processor based implementation of an observer device 600 which may be utilized for implementing the above concepts. The observer device 600 may for example implement one of the above-mentioned observer devices 20.

As illustrated, the observer device 600 is provided with a PBS interface 610. The PBS interface 610 may be used for receiving positioning signals, such as the above-mentioned PBS transmitted by the tag device 10. In addition, the PBS interface 610 may also be used for receiving motion data, such as the motion data provided by the motion sensor 14 of the tag device 10. The PBS interface 610 may for example support a BLE technology or UWB technology. However, other radio technologies or even non-radio technologies, such as ultrasound, could be utilized as well.

As further illustrated, the observer device 600 includes a data interface 620. The observer device 600 may utilize the data interface 620 for providing positioning data derived from at least one positioning signal to a device which is responsible for calculating an object position from the positioning data, e.g., to the locator device 100 as described in the scenario of FIG. 1. The data interface 620 may be a wireless interface, e.g., based on a Bluetooth technology or a Wi-Fi technology. However, the data interface 620 could also be a wire based interface, such as a USB interface or an Ethernet interface.

Further, the observer device 600 is provided with one or more processors 640 and a memory 650. The interfaces 610, 620 and the memory 650 are coupled to the processor(s) 640, e.g., using one or more internal bus systems of the observer device 600.

The memory 650 includes program code modules 660, 670 with program code to be executed by the processor(s) 640. In the illustrated example, these program code modules include a processing module 660 and a control module 670.

The position processing module 660 may implement the above-described functionalities of processing one or more positioning signals or of processing positioning data derived from one or more positioning signals, e.g., by sampling, averaging, and/or filtering. The control module 670 may implement the above-described functionalities of determining a processing time window to be applied in this processing, or of selecting filters or other algorithms to be applied in this processing.

It is to be understood that the structures as illustrated in FIG. 6 are merely exemplary and that the observer device 600 may also include other elements which have not been illustrated, e.g., structures or program code modules for implementing known functionalities of a receiver for positioning signals.

FIG. 7 shows a block diagram for schematically illustrating a processor based implementation of a locator device 700 which may be utilized for implementing the above concepts. The locator device 700 may for example implement the above-mentioned locator device 100 or 100′.

As illustrated, the locator device 700 is provided with a positioning interface 710. The positioning interface 710 may be used for receiving positioning signals, such as the above-mentioned PBS transmitted by the tag device 10. However, in some scenarios the positioning interface 710 could also be used for receiving positioning data derived from one or more positioning signals, such as the positioning data provided by the observer devices 20 in the scenario of FIG. 1. In addition, the positioning interface 710 may also be used for receiving motion data, such as the motion data provided by the motion sensor 14 of the tag device 10. When used for receiving positioning signals, the positioning interface 710 may for example support a BLE technology or UWB technology. However, other radio technologies or even non-radio technologies, such as ultrasound, could be utilized as well. When used for receiving positioning data derived from one or more positioning signals, the positioning interface 710 could for example support a wireless communication technology, such as a Bluetooth technology or a Wi-Fi technology, or a wire based communication technology, such as a USB technology or an Ethernet technology.

Further, the locator device 700 is provided with one or more processors 740 and a memory 750. The interface 710 and the memory 750 are coupled to the processor(s) 740, e.g., using one or more internal bus systems of the locator device 700.

The memory 750 includes program code modules 760, 770 with program code to be executed by the processor(s) 740. In the illustrated example, these program code modules include a processing module 760 and a control module 770.

The position processing module 760 may implement the above-described functionalities of processing one or more positioning signals or of processing positioning data derived from one or more positioning signals, e.g., by sampling, averaging, and/or filtering. The control module 770 may implement the above-described functionalities of determining a processing time window to be applied in this processing, or of selecting filters or other algorithms to be applied in this processing.

It is to be understood that the structures as illustrated in FIG. 7 are merely exemplary and that the locator device 700 may also include other elements which have not been illustrated, e.g., structures or program code modules for implementing known functionalities for evaluation of positioning signals.

It is to be understood that the concepts as explained above are susceptible to various modifications. For example, the concepts could be applied in connection with various kinds of positioning signal types and positioning algorithms. Further, the concepts may utilize various types of tag devices. Still further, it is noted that in some scenarios also multiple tag devices could be used on the same object.

1. A method of estimating an object position, the method comprising:
receiving at least one positioning signal from a transmitter on an object;
receiving motion data from a sensor on the object;
based on the received motion data, determining a processing time window; and
based on the determined processing time window, processing the at least one positioning signal and/or positioning data derived from the at least one positioning signal.

2. The method according to claim 1, further comprising:
based on the processed at least one positioning signal, calculating the positioning data.

3. The method according to claim 1, further comprising:
sending the positioning data to a device which is responsible for calculating a position of the object from the positioning data.

4. The method according to claim 1, comprising:
in response to the motion data indicating a first motion status, selecting a first length of the processing time window; and
in response to the motion data indication a second motion status with a lower mobility than the first motion status, selecting a second length of the processing time window which is longer than the first length.

5. The method according to claim 1,
wherein said processing comprises averaging of the at least one positioning signal and/or of the positioning data and the processing time window is a time window applied for said averaging.

6. The method according to claim 1,
wherein said processing comprises sampling of the at least one positioning signal and the processing time window is a time window applied for sampling of the at least one positioning signal.

7. The method according to claim 1, comprising:
based on the received motion data, selecting a sampling rate applied for sampling of the at least one positioning signal.

8. The method according to claim 1, comprising:
based on the received motion data, selecting an algorithm applied for said processing.

9. The method according to claim 8, comprising:
based on the received motion data, selecting a filter applied for said processing.

10. The method according to claim 1,
wherein the sensor comprises an accelerometer.

11. The method according to claim 1,
wherein the sensor comprises a gyroscope.

12. The method according to claim 1,
wherein the transmitter and the sensor are comprised in a tag device attached to the object.

13. A device for estimating an object position, the device comprising:
an interface for receiving at least one positioning signal from a transmitter on an object or for receiving positioning data derived from at least one positioning signal from a transmitter on an object, and for receiving motion data from a sensor on the object; and
at least one processor configured to:
based on the received motion data, determine a processing time window; and
based on the determined processing time window, process the at least one positioning signal or the positioning data derived from the at least one positioning signal based on the determined processing time window.

14. The device according to claim 13, comprising:
a further interface configured for sending positioning data calculated based on the processed at least one positioning signal to a further device which is responsible for calculating a position of the object from the positioning data.

15. (canceled)

16. A system, comprising:
the device according to claim 13; and
a tag device attached to the object, the tag device comprising the transmitter and the sensor.
